(19) United States
(12) Patent Application Publication
(10) Pub. No.: US 2008/0293848 A1
(43) Pub. Date: Nov. 27, 2008

(54) SELF-POLISHING ANTI-FOULING COMPOSITIONS

(75) Inventors: Revathi R. Tomko, North Olmsted, OH (US); Dino D. Papagianidis, Hattiesburg, MS (US); John A. Joecken, Palm Springs, CA (US); James M. Reuter, Cleveland Heights, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/055,697

(22) Filed: Mar. 26, 2008

Related U.S. Application Data
(60) Provisional application No. 60/908,465, filed on Mar. 28, 2007.

(51) Int. Cl. C09D 5/16

(52) U.S. Cl. 523/122

(57) ABSTRACT

A self-polishing anti-fouling marine coating composition that is free of heavy metal biocides. The coating composition comprises a polymer binder comprising a film forming polymer having a hydrolysable functional group on the polymer backbone; and a blend of at least two biocidally active materials, the blend comprising a 2-trihalogenomethyl-3-halogeno-4-cyanopyrrole compound and a second biocidally active material.

### CROSS-REFERENCE TO RELATED APPLICATION

This application claims the benefit of U.S. provisional patent application number 60/908,465 filed on Mar. 28, 2007, the entirety of which is hereby incorporated by reference.

### TECHNICAL FIELD

This invention relates to coating compositions for marine applications, and in particular, to self-polishing anti-fouling compositions free of heavy metal biocidally active materials.

### BACKGROUND

Marine fouling is the settlement and growth of marine organisms such as plants, animals and slime on underwater structures, ship hulls and cooling water intake lines of power plants. Marine fouling increases the weight of underwater structures, weakens the structures, and increases corrosion. It also increases the surface roughness of ship hulls, increases the drag, reduces the speed, and increases fuel consumption and operating costs. Marine fouling can clog the water intake lines of power plants and lead to plant shut down. Eliminating or reducing the effects of marine fouling is complicated, as there are twelve well-defined zones in the oceans of the world that differ in salinity, clarity, nature, and amount of micronutrients. The numbers and types of native fouling organisms differ from zone to zone. Barnacles, mussels, and bryozoans cause hard fouling. Algae, slime, tunicates, diatoms, bacteria, and hydroids cause soft fouling. The means by which these fouling organisms attach themselves to immersed man made structures are all different.

Anti-fouling coatings, which contain biocidally active materials, can be effective in eliminating or reducing fouling. Algaecides and fungicides generally kill soft fouling organisms, while molluscicides are effective against hard fouling organisms. It should also be noted that the classification of a compound as a molluscicide does not guarantee its effectiveness against marine hard fouling. A compound effective against one type of species in one part of the world may not be effective against other species. Challenges also exist in making stable anti-fouling coatings, since many anti-fouling compounds are not compatible with the coating ingredients and/or binder systems.

For an anti-fouling coating to be effective over a long period of time, the biocide should have broad spectrum activity over various types of fouling in different waters and climatic conditions. The coating desirably has low water solubility so that the coating will release at a slow, steady rate during the lifetime of the coating. Ideally, the delivery system of the coating has a controlled erosion rate so that it will erode gradually and carry the biocide with it. Delivery systems currently used in marine anti-fouling coatings are generally classified as one of ablative, insoluble matrix, non-toxic foul release, and self-polishing technologies.

Self-polishing coatings generally comprise binders that contain copolymers that, upon hydrolysis, release a biocide. The copolymers remaining after the loss of the water soluble biocide slowly self polish. This uniform dissolution of the copolymers also helps keep the surface of the coating smooth. The first self-polishing system used was based on a tin polymer, such as an organotin acrylate, bound to the polymer backbone. While undergoing a controlled hydrolysis at a pH of 8.00, an organotin oxide that kills soft fouling organisms is released. The polymer backbone that remains is hydrophilic and slowly dissolves in seawater. Other self-polishing systems incorporate a cuprous oxide dispersed in a binder having a slowly hydrolysable component. Since the hydrolysis and dissolution occurs at the surface in a controlled manner, release of the tin oxide and cuprous oxide is uniform, enabling these coatings to last up to five years.

Coating compositions containing organotin compounds, and in particular, tributyltin (TBT), are especially problematic since they can cause contamination of the seawater and environment and kill non-targeted organisms. In 2001, the United Nations' International Maritime Organization (IMO) proposed a global ban on the use of TBT based anti-fouling systems. The proposal would ban the application of TBT on ships by 2003 and prohibit the presence of TBT-containing coatings on ships by 2008. While the necessary number of countries has not ratified the treaty, several countries, including the United States and the European Union, have voluntarily implemented the ban.

Other self-polishing systems based on copper acrylate and zinc acrylate bound to the polymer backbone have been available. However, these coatings are formulated with cuprous oxide in the paint formulations, and are thus classified as heavy-metal based. The major disadvantage to the anti-fouling systems available is the use of common heavy-metal anti-fouling biocides containing organotin compounds, or copper (such as cuprous oxide), antimony and bismuth compounds.

It would be desirable, therefore, to provide a self-polishing anti-fouling coating composition that is free of heavy metal biocidal agents.

### SUMMARY

In one embodiment, there is provided a marine self-polishing anti-fouling coating composition comprising: a polymer binder comprising a film forming polymer having a functional group on the polymer backbone, the functional group chosen from (a) an amine functional group, (b) a cyclic amide functional group, (c) an acid functional group, and (d) a blocked acid functional group; and a blend of at least two biocidally active materials, the blend comprising a 2-trihalogenomethyl-3-halogeno-4-cyanopyrrole derivative and a second biocidally active material, wherein the coating composition is free of heavy metal containing biocidally active materials.

The film forming polymer, in one embodiment, is formed from at least one acrylic or methacrylic monomer and at least one amine functional monomer. In another embodiment, the film forming polymer is formed from at least one acrylic or methacrylic monomer and at least one cyclic amine functional monomer. In yet another embodiment, the film forming polymer is formed from at least one acrylic or methacrylic monomer and at least one acid containing monomer. The film forming polymer may comprise an acid-functional polymer whose acid groups are blocked by groups capable of hydrolyzing to leave a polymer soluble in seawater, the blocking groups comprising quaternary ammonium groups that form a quaternary ammonium salt of the polymers.

In one embodiment, there is provided a marine self-polishing anti-fouling coating composition comprising: a polymer binder comprising a film forming polymer having a functional group on the polymer backbone, the functional group chosen from (a) an amine functional group, (b) a cyclic amide functional group, (c) an acid functional group, and (d) a blocked acid functional group; and a blend of at least two biocidally active materials, the blend comprising 2-(p-chlorophenyl)-3-cyano-4-bromo-5-trifluoromethyl pyrrole and N-dichlorofluoromethylthio-N′, N′-dimethyl-N-p-toyl-sulphamide, wherein the coating composition is free of heavy metal containing biocidally active materials.

A method of coating a man made structure immersed in water is provided. The method comprises coating the structure with a marine self-polishing anti-fouling coating composition comprising: a polymer binder comprising a film forming polymer having a functional group on the polymer backbone, the functional group chosen from (a) an amine functional group, (b) a cyclic amide functional group, (c) an acid functional group, and (d) a blocked acid functional group; and a blend of at least two biocidally active materials, the blend comprising a 2-trihalogenomethyl-3-halogeno-4-cyanopyrrole derivative and a second biocidally active material, wherein the coating composition is free of heavy metal containing biocidally active materials.

### DETAILED DESCRIPTION

The coating composition of the present invention is a marine self-polishing, anti-fouling coating composition. In one embodiment, the coating composition comprising: a polymer binder comprising a film forming polymer having a functional group on the polymer backbone, the functional group chosen from (a) an amine functional group, (b) a cyclic amide functional group, (c) an acid functional group, and (d) a blocked acid functional group; and a blend of at least two biocidally active materials, the blend comprising a 2-trihalogenomethyl-3-halogeno-4-cyanopyrrole derivative and a second biocidally active material, wherein the coating composition is free of heavy metal containing biocidally active materials.

The polymer binder comprises a film forming polymer made up of a polymer backbone onto which there is attached at least one functional group. As used herein, the term “film forming polymer” means any polymeric material that can form a film from evaporation of any carrier or solvent. The polymer backbone may be an acrylic, polyester, polyurethanes, alkyd or polyolefin polymer.

The film forming polymer includes a functional group on the polymer backbone that can self-polish by hydration or hydrolysis. The functional group may be chosen from (a) an amine functional group, (b) a cyclic amide functional group, (c) an acid functional group, and (d) a blocked acid functional group.

In one embodiment, the polymer backbone is an acrylic polymer derived from one or more acrylate or methacrylate monomers. The acrylates include C₁ to about C₂₀ alkyl, aryl or cyclic acrylates such as methyl acrylate, ethyl acrylate, phenyl acrylate, butyl acrylate, 2-ethylhexyl acrylate, isobornyl acrylate and functional derivatives of these acrylates such as 2-hydroxy ethyl acrylate, 2-chloro ethyl acrylate, and the like. These compounds typically contain from about 3 to about 20 carbon atoms, and in one embodiment about 3 to about 8 carbon atoms. The methacrylates include C₁ to about C₂₀ alkyl, aryl or cyclic methacrylates such as methyl methacrylate, ethyl methacrylate, butyl methacrylate, 2-ethylhexyl methacrylate, phenyl methacrylate, isobornyl methacrylate, and functional derivatives of these methacrylates such as 2-hydroxyethyl methacrylate, 2-chloroethyl methacrylate, and the like. These compounds typically contain from about 4 to about 20 carbon atoms, and in one embodiment about 4 to about 8 carbon atoms.

The acrylic polymer may be a copolymer derived from at least one acrylate monomer and at least one polymerizable comonomer. The polymerizable comonomers include acrylonitriles, acrylamides, methacrylamides, vinyl esters, vinyl ethers, vinyl amides, vinyl ketones, styrenes, halogen containing monomers, ionic monomers, acid containing monomers, base containing monomers, monomers having both a reactive silicon containing group and a polymerizable unsaturated group, olefins, and mixtures of two or more thereof.

In one embodiment, the film forming polymer of the self-polishing paint comprises a copolymer prepared by the polymerization of at least one (meth)acrylic comonomer and at least one alkyl amino alkyl (meth)acrylate monomer, such as dimethyl amino ethyl methacrylate, diethyl amino ethyl methacrylate, dipropyl amino ethyl methacrylate, dibutyl amino ethyl methacrylate or acrylate esters thereof and the like.

In one embodiment the film forming polymer comprises a copolymer prepared by the polymerization of at least one acrylic comonomer and at least one cyclic amide having the general formula:

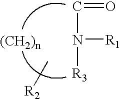

wherein R₁ is selected from H and alkyl groups when R₂ is an alkenyl group, R₁ is an alkenyl group when R₂ is selected from hydrogen and alkyl groups, R₃ is selected from methylene and carbonyl, and n is a positive integer.

The cyclic amide, is one embodiment, is selected from cyclic tertiary amides having a vinyl or alkenyl function, including N-vinylpyrrolidone, N-vinylpiperidone, and N-vinyl caprolactam.

In one embodiment, the film forming polymer comprises a copolymer prepared by the polymerization of at least one (meth)acrylic comonomer and at least one acid containing monomer. The acid containing monomers include unsaturated carboxylic acids containing from 3 to about 5 carbon atoms. The unsaturated carboxylic acids include, among others, acrylic acid, methacrylic acid, itaconic acid, beta carboxy ethyl acrylate and the like.

In one embodiment, the film forming polymer comprises an acid-functional film polymer whose acid groups are blocked by groups capable of hydrolyzing, dissociating or exchanging with seawater species to leave a polymer soluble in seawater. The blocked acid polymer is preferably an acid-functional polymer whose acid groups are blocked by quaternary ammonium groups that form a quaternary ammonium salt of the polymer. The quaternary ammonium group can be tetra-alkyl or it can contain one or more alkoxyalkyl, cycloalkyl, aryl or aralkyl groups. More generally, the organic groups in the quaternary ammonium group may be saturated or unsaturated, aliphatic, cycloaliphatic, aromatic, aliphatic-aromatic or heterocyclic.

The quaternary ammonium moiety preferably contains at least one organic group containing at least 3 carbon atoms, advantageously at least 8 carbon atoms and preferably from 8 to 25 carbon atoms (for example 8 to 20 carbon atoms), and more especially from 12 to 25 carbon atoms. The polymers containing a relatively long chain quaternary ammonium group have a decreased rate of dissolution in seawater. Examples of such quaternary ammonium groups are dodecyl trimethyl ammonium, hexadecyl trimethyl ammonium, octadecyl trimethyl ammonium, oleyl trimethyl ammonium, benzyl dodecyl dimethyl ammonium, dodecyl dimethyl octyl ammonium or trioctyl methyl ammonium. The quaternary group can alternatively be derived from rosin. In one embodiment, the quaternary ammonium group is derived from dehydroabietyl amine. Advantageously, the total number of carbon atoms in the quaternary ammonium moiety is 8 or more, preferably 12 or more (for example, from 12 to 40).

The acid-functional film forming polymer whose acid groups are blocked by groups capable of hydrolyzing, dissociating or exchanging with seawater species to leave a polymer soluble in seawater is alternatively an acid-functional polymer whose acid groups are blocked by quaternary phosphonium groups which form a quaternary phosphonium salt of the polymer. The quaternary phosphonium group can be tetra-alkyl or it can contain one or more alkoxyalkyl, cycloalkyl, aryl or aralkyl groups. More generally the organic groups in the quaternary phosphonium group may be saturated or unsaturated, aliphatic, cycloaliphatic, aromatic, aliphatic-aromatic or heterocyclic. Examples of such quaternary phosphonium groups are tetrabutylphosphonium, tetraphenylphosphonium and stearyltributylphosphonium.

The acid-functional polymer may comprise an addition copolymer of an olefinically unsaturated carboxylic acid and at least one unsaturated co-monomer. The unsaturated carboxylic acid can for example be acrylic or methacrylic acid or an acid functional ester or amide of acrylic acid or methacrylic acid. The unsaturated comonomer can for example be an ester or amide of an alkyl, alkoxyalkyl, carbocylic or heterocyclic alcohol or amine with an unsaturated carboxylic acid, such as methyl acrylate or methacrylate, butyl acrylate or methacrylate and isobornyl acrylate or methacrylate and the like. Alternatively the unsaturated co-monomer may be a vinylic compound, for example styrene, vinyl pyrollidone or vinyl acetate.

The acid-functional film forming polymer whose acid groups are blocked by quaternary ammonium groups which form a quaternary ammonium salt of the polymer can be prepared by reaction of a polymer containing acid or acid-salt groups with a quaternary ammonium compound. Alternatively, it can be prepared by polymerization of a quaternary ammonium salt of an ethylenically unsaturated acid-functional monomer formed, for example, by reaction of an ethylenically unsaturated monomer containing acid or acid-salt groups with a quaternary ammonium compound. Examples of suitable acid-salts groups include metal salts such as sodium, potassium and lithium salts, or amine salts such as ammonium or hydroxyethyldimethylammonium salts and the like. Examples of suitable quaternary ammonium compounds include quaternary ammonium hydroxides, carbonates, bicarbonates, sulphates, bisulphates or halides.

The film forming polymer may be synthesized using solution, emulsion, and batch polymerization techniques. In one embodiment, it is preferred to prepare the copolymer in solution using a mixture of solvents. Examples of useful solvents include methyl toluene and propylene glycol n-propylether (PNP). Solids content during polymerization may typically range from about 30% to about 60% in order to achieve the desired weight average molecular weight, and yet achieve viscosities that are manageable in the reactor.

Reaction may occur in the presence of free-radical initiators, such as initiators of the azo type, for example, 2,2′-azobis (isobutyronitrile). Other initiators include peroxides initiators, including dialkyl peroxides such as di-t-butyl peroxide, 2, 5-dimethyl-2, 5-di(t-butylperoxy)hexane, 2,5-dimethyl-2,5-di(t-butylperoxy)-3-hexyne, dicumyl peroxide, t-butyl cumyl peroxide and α, α′-bis(t-butylperoxy) isopropylbenzene, diacyl peroxides such as benzoyl peroxide, p-chlorobenzoyl peroxide, m-chlorobenzoyl peroxide, 2,4-dichlorobenzoyl peroxide, lauroyl peroxide, peroxy esters such as t-butyl perbenzoate, peroxydicarbonates such as diisopropyl peroxydicarbonate and di-2-ethylhexyl peroxydicarbonate, peroxy ketals such as 1,1-di(t-butylperoxy) cyclohexane and 1,1-di(t-butylperoxy)-3,3,5-trimethylcyclohexane and the like.

The film forming polymer can be mixed with an effective amount of at least one biocidally active material that has anti-fouling activity. The biocidally active material can be a heavy metal free biocide. By this invention, a “heavy metal free biocide” means that the biocide is completely or substantially free of the metals copper, tin, antimony and arsenic, including the metal oxides such as cuprous oxide, tin oxide, antimony oxide, and arsenic oxide, and so on. The biocide can be used in combination with a co-biocide. The anti-fouling coating composition can comprise any combination of a variety of biocides, such as heavy metal free algaecides, fungicides, insecticides, molluscicides and bactericides. The biocides are used in such an amount that the proportion thereof in the solid contents of the coating composition is from about 0.1 to about 90% by weight, preferably from about 0.1 to about 80% by weight, and more preferably from about 1 to about 50% by weight.

The release of the active biocide material imparts the effective anti-fouling activity, and is dependent on the hydrolysis or self-polishing rate of the binder delivery system. The binder hydrolyzes in the seawater (at pH 8.0) at the proper rate so that a sufficient amount of the active biocide is present at the coating surface to continuously prevent barnacles and algae from attaching. Hydrolysis and self-polishing rates of the polymers can be determined by titration methods or by using a turboeroder that measures the rate of self-polishing over a period of time.

Preferably, the biocides employed are degradable in seawater. For example, the anti-fouling coating composition can comprise one or more of about 2% by weight to about 20% by weight of a molluscicide based on 2-trihalogenmethyl-3-halogeno-4-cyanopyrrole compound and about 2% by weight to about 20% by weight of a cobiocide based on a variety of algaecides (phthalimides, sulfamides, triazines, oxathiazines, isothiazoline-3-ones, pyrithiones). Particularly useful 2-trihalogenomethyl-3-halogeno-4-cyanopyrrole compounds include 2-(p-chlorophenyl)-3-cyano-4-bromo-5-trifluoromethyl pyrrole and 2-trifluoromethyl-3-chloro-4-cyanopyrrole.

Examples of these metal-free organic compounds include N-trihalomethylthiophthalimides, trihalomethylthiosulfamides, dithiocarbamic acids, N-arylmaleimides, 3-(substituted amino)-1,3-thiazolidine-2,4-diones, dithiocyano compounds, triazine compounds, oxathiazines, and others.

Examples of the N-trihalomethylthiophthalimides include N-trichloromethylthiophthalimide and N-fluorod ichloromethylthiophthalimide. Examples of the dithiocarbamic acids include bis(dimethylthiocarbamoyl) disulfide, ammonium N-methyldithiocarbamate and ammonium ethylene-bis(dithiocarbamate).

Examples of trihalomethylthiosulfamides include N-(dichlorofluoro-methylthio)-N′, N′-dimethyl-N-phenylsulfamide and N-(dichlorofluoromethylthio) -N′, N′-dimethyl-N-(4-methylphenyl)sulfamide.

Examples of the N-arylmaleimides include N-(2,4,6-trichlorophenyl) maleimide, N-4-tolylmaleimide, N-3-chlorophenylmaleimide, N-(4-n-butylphenyl) maleimide, N-(anilinophenyl)maleimide, and N-(2,3-xylyl)maleimide.

Examples of the 3-(substituted amino)-1,3-thiazolidine-2,4-diones include 2-(thiocyanomethylthio)-benzothiazole, 3-benzylideneamino-1,3-thi-azolidine-2,4-dione, 3-(4-methylbenzylideneamino)-1,3-thiazoline-2,4-dione, 3-(2-hydroxybenzylideneamino)-1, 3-thiazolidine-2,4-dione, 3-(4-dimethyl-amino-benzylideneamino)-1,3-thiazolidine-2,4-dione, and 342,4-dichloro-benzylidene-amino)-1,3-thiazolidine-2,4-dione.

Examples of the dithiocyano compounds include dithiocyanomethane, dithiocyanoethane, and 2,5-dithiocyanothiophene.

Examples of the triazine compounds include 2-methylthio-4-t-butylamino-6-cyclopropylamino-s-triazine. Examples of oxathiazines include 1,2,4-oxathiazine and their mono- and di-oxides such as disclosed in WO 98/05719, which is incorporated by reference herein.

Other examples of the metal-free organic compounds include 2,4,5,6-tetrachloroisophthalonitrile, N,N-dimethyl-dichlorophenylurea, 4,5-dichloro-2-n-octyl-4-isothiazolin-3-one, N, N-dimethyl-N′-phenyl-(N-fluorodichloromethyl-thio) sulfamide, tetramethylthiouramdisulfide, 3-iodo-2-propinylbutyl carbamate, 2-(methoxycarbonylamino) benzimidazole, 2,3,5, 6-tetrachloro-4-methylsulfonyl) pyridine, diiodomethyl-p-tolyl sulfone, 2-(4-thiazolyl) benzimidazole, and N-methylol formamide.

The paint composition can also comprise one or more pigments that are not reactive with seawater and highly insoluble in seawater, such as titanium dioxide, talc or calcium carbonate. Such non-reactive and highly insoluble pigments can be used at up to 70 percent by weight of the total pigment component of the paint. The coating composition can additionally contain conventional solvent(s), thickener(s), stabilizer(s), pigment(s) or other additives.

The coating composition can be applied to any articles or surfaces that are to be protected, particularly those that would come in contact with marine environment, such as various kinds of ship hulls (especially aluminum hulls), underwater structures, fish nets, ship bottoms, and other man made structures.

The invention is described further by the following examples, which are intended to be illustrative and by no means limiting. All references to parts and percentages are by weight unless otherwise indicated.

### EXAMPLES

### Example 1A

### Preparation Of Amine Acrylic

Into a polymerization reactor, fitted with a mechanical stirrer, a water cooled condenser, a nitrogen inlet, thermometer, a heating mantle and a fluid metering pump is charged 1417.57 parts propylene glycol n-propyl ether (PNP). The solvent is heated to 100° C. A monomer/initiator mixture of 858.48 parts methyl methacrylate (MMA), 398.93 parts 2-ethyhexylacrylate (2-EHA), 531.90 parts N-N-dimethylaminoethyl methacrylate, and 870.19 parts butyl methacrylate (BMA) and 66.49 parts Vazo 67 is metered into the reactor at a constant rate over a three hour time period. The reaction is held at 100° C. for one hour after completing the monomer/initiator addition. Next, 52.43 parts PNP and 4.00 parts Vazo 67 are added over 30 minutes. The reaction is then held at 100° C. for an additional 45 minutes. The reaction mixture is allowed to cool to 70° C. and then poured off. The Tg of the amine acrylic polymer is 25° C.

### Example 1 B

### Preparation Of Amine Acrylic

Into a polymerization reactor, fitted with a mechanical stirrer, a water cooled condenser, a nitrogen inlet, thermometer, a heating mantle and a fluid metering pump is charged 597.96 parts propylene glycol n-propyl ether (PNP). The solvent is heated to 100° C. A monomer/initiator mixture of 646.46 parts methyl methacrylate (MMA), 167.89 parts butyl acrylate (BA), 271.45 parts N-N-dimethylaminoethyl methacrylate, and 271.45 parts butyl methacrylate (BMA) and 27.14 parts Vazo 67 is metered into the reactor at a constant rate over a three hour time period. The reaction is held at 100° C. for one hour after completing the monomer/initiator addition. Next, 2.04 parts PNP and 2.04 parts Vazo 67 are added over 30 minutes. The reaction is then held at 100° C. for an additional 45 minutes. The reaction mixture is allowed to cool to 70° C. and then poured off. The Tg of the amine acrylic polymer is 40° C.

### Example 1 C

### Preparation Of Amine Acrylic

Into a polymerization reactor, fitted with a mechanical stirrer, a water cooled condenser, a nitrogen inlet, thermometer, a heating mantle and a fluid metering pump is charged 574.40 parts xylene. The solvent is heated to 100° C. A monomer/initiator mixture of 405.45 parts methyl methacrylate (MMA), 188.41 parts 2-ethylhexyl acrylate (2-EHA), 251.21 parts N-N-dimethylaminoethyl methacrylate, and 410.98 parts butyl methacrylate (BMA) and 31.40 parts Vazo 67 is metered into the reactor at a constant rate over a 210 minute time period. The reaction is held at 100° C. for one hour after completing the monomer/initiator addition. Next, 125.60 parts xylene and 12.56 parts Vazo 67 are added over 30 minutes. The reaction is then held at 100° C. for an additional 30 minutes. The reaction mixture is allowed to cool to 70° C. and then poured off.

### Example 2A

### Preparation Of Anti-Fouling Paint

The following formula is used to prepare an anti-fouling paint:

| | % by weight |
|---|---|
| Amine acrylic of Example 1A | 27.18 |
| Bentone 38 | 1.07 |
| Anti-Terra U Dispersant | 4.21 |
| Calcium Carbonate | 8.89 |
| Talc Micronized Flaky | 9.21 |
| Lo Micron Barytes | 14.32 |
| Precipitated Red Oxide | 2.36 |
| Xylene | 15.93 |
| AF 028 | 9.84 |
| N-dichlorofluoromethylthio-N′,N′-dimethyl-N-p-toyl- | 6.98 |
| sulphamide | |

### Example 2B

### Preparation Of Anti-Foulinq Paint

The following formula is used to prepare an anti-fouling paint:

| | % by weight |
|---|---|
| Amine acrylic of Example 1B | 32.91 |
| Bentone 38 | 1.23 |
| Anti-Terra U Dispersant | 3.99 |
| Calcium Carbonate | 10.19 |
| Talc Micronized Flaky | 10.55 |
| Lo Micron Barytes | 16.41 |
| Precipitated Red Oxide | 2.70 |
| Xylene | 13.17 |
| AF 028 | 5.65 |
| N-dichlorofluoromethylthio-N′,N′-dimethyl-N-p-toyl- | 3.20 |
| sulphamide | |

### Example 3A

### Preparation Of Cyclic Amide

Into a polymerization reactor, fitted with a mechanical stirrer, a water cooled condenser, a nitrogen inlet, thermometer, a heating mantle and a fluid metering pump is charged 837.74 parts propylene glycol n-propyl ether (PNP). The solvent is heated to 100° C. A monomer/initiator mixture of 142.57 parts methyl methacrylate (MMA), 301.74 parts n-vinyl pyrrolidone, 310.04 parts butyl acrylate (BA), 301.74 parts styrene, 452.61 parts butyl methacrylate (BMA) 45.26 parts Vazo 67, and 3.77 parts mercaptoethanol is metered into the reactor at a constant rate over a five hour time period. The reaction is held at 100° C. for 30 minutes after completing the monomer/initiator addition. Next, 90.00 parts PNP and 2.26 parts Vazo 67 are added over 30 minutes. The reaction is then held at 100° C. for an additional one hour. The reaction mixture is allowed to cool to 70° C. and then poured off. The Tg of the amine acrylic polymer is 40° C.

### Example 3B

### Preparation Of Cyclic Amide

Into a polymerization reactor, fitted with a mechanical stirrer, a water cooled condenser, a nitrogen inlet, thermometer, a heating mantle and a fluid metering pump is charged 837.74 parts propylene glycol n-propyl ether (PNP). The solvent is heated to 100° C. A monomer/initiator mixture of 438.73 parts methyl methacrylate (MMA), 301.74 parts n-vinyl pyrrolidone, 315.62 parts butyl acrylate (BA), 452.61 parts butyl methacrylate (BMA) 45.26 parts Vazo 67, and 3.77 parts mercaptoethanol is metered into the reactor at a constant rate over a five hour time period. The reaction is held at 100° C. for 30 minutes after completing the monomer/initiator addition. Next, 90.00 parts PNP and 2.26 parts Vazo 67 are added over 30 minutes. The reaction is then held at 100° C. for an additional one hour. The reaction mixture is allowed to cool to 70° C. and then poured off. The Tg of the amide acrylic polymer is 40° C.

### Example 4

### Preparation Of Anti-Fouling Paint

The following formula is used to prepare an anti-fouling paint:

| | % by weight |
|---|---|
| Cyclic amide acrylic of Example 3B | 26.77 |
| Bentone 38 | 1.07 |
| Anti-Terra U Dispersant | 4.19 |
| Calcium Carbonate | 8.85 |
| Talc Micronized Flaky | 9.16 |
| Lo Micron Barytes | 14.25 |
| Precipitated Red Oxide | 2.34 |
| Xylene | 16.61 |
| AF 028 | 9.82 |
| N-dichlorofluoromethylthio-N′,N′-dimethyl-N-p-toyl- | 6.95 |
| sulphamide | |

### Example 5A

### Preparation Of Acid Acrylic

Into a polymerization reactor, fitted with a mechanical stirrer, a water cooled condenser, a nitrogen inlet, thermometer, a heating mantle and a fluid metering pump is charged 764.93 parts propylene glycol n-propyl ether (PNP). The solvent is heated to 100° C. A monomer/initiator mixture of 197.33 parts methyl methacrylate (MMA), 151.97 parts methacrylic acid, 235.21 parts butyl acrylate, 584.51 parts butyl methacrylate (BMA), 23.38 parts Vazo 67 and 5.85 parts mercaptoethanol is metered into the reactor at a constant rate over a three and a half hour time period. The reaction is held at 100° C. for 30 minutes after completing the monomer/initiator addition. Next, 35.07 parts PNP and 1.75 parts Vazo 67 are added over 30 minutes. The reaction is then held at 100° C. for an additional 30 minutes. The reaction mixture is allowed to cool to 70° C. and then poured off. The Tg of the amine acrylic polymer is 25° C.

### Example 5B

### Preparation Of Acid Acrylic

Into a polymerization reactor, fitted with a mechanical stirrer, a water cooled condenser, a nitrogen inlet, thermometer, a heating mantle and a fluid metering pump is charged 698.11 parts propylene glycol n-propyl ether (PNP). The solvent is heated to 100° C. A monomer/initiator mixture of 468.45 parts methyl methacrylate (MMA), 163.44 parts methacrylic acid, 248.18 parts butyl acrylate, 377.18 parts butyl methacrylate (BMA), 37.72 parts Vazo 67 and 3.14 parts mercaptoethanol is metered into the reactor at a constant rate over a three hour time period. The reaction is held at 100° C. for 30 minutes after completing the monomer/initiator addition. Next, 1.89 parts PNP and 3.14 parts Vazo 67 are added over 30 minutes. The reaction is then held at 100° C. for an additional 45 minutes. The reaction mixture is allowed to cool to 70° C. and then poured off. The Tg of the amine acrylic polymer is 40° C.

### Example 5C

### Preparation Of Acid Acrylic

Into a polymerization reactor, fitted with a mechanical stirrer, a water cooled condenser, a nitrogen inlet, thermometer, a heating mantle and a fluid metering pump is charged 805.75 parts propylene glycol n-propyl ether (PNP). The solvent is heated to 100° C. A monomer/initiator mixture of 608.46 parts methyl methacrylate (MMA), 91.41 parts methacrylic acid, 214.20 parts butyl acrylate, 609.38 parts butyl methacrylate (BMA), 30.47 parts Vazo 67 and 3.81 parts mercaptoethanol is metered into the reactor at a constant rate over a five hour time period. The reaction is held at 100° C. for 30 minutes after completing the monomer/initiator addition. Next, 34.28 parts PNP and 2.29 parts Vazo 67 are added over 30 minutes. The reaction is then held at 100° C. for an additional 45 minutes. The reaction mixture is allowed to cool to 70° C. and then poured off. The Tg of the amine acrylic polymer is 40° C.

### Example 6

### Preparation Of Anti-Fouling Paint

The following formula is used to prepare an anti-fouling paint:

| | % by weight |
|---|---|
| Acid acrylic of Example 5B | 30.17 |
| Bentone 38 | 1.12 |
| Anti-Terra U Dispersant | 4.19 |
| Calcium Carbonate | 8.54 |
| Talc Micronized Flaky | 8.84 |
| Lo Micron Barytes | 13.76 |
| Precipitated Red Oxide | 2.47 |
| Xylene | 13.25 |
| AF 028 | 10.34 |
| N-dichlorofluoromethylthio-N′,N′-dimethyl-N-p-toyl- | 7.32 |
| sulphamide | |

### Example 7

### Preparation Of Blocked Acid Acrylic

The acid acrylic of Example 5A, in an amount of 250 grams, is neutralized with 51.67 grams of dehydroabietyl amine to form a blocked acid acrylic.

### Example 8

### Preparation Of Anti-Fouling Paint

The following formula is used to prepare an anti-fouling paint:

| | % by weight |
|---|---|
| Blocked acid acrylic of Example 7 | 54.43 |
| Bentone 38 | 1.43 |
| Calcium Carbonate | 11.55 |
| Lo Micron Barytes | 3.82 |
| Precipitated Red Oxide | 4.07 |
| Xylene | 11.65 |
| AF 028 | 8.40 |
| N-dichlorofluoromethylthio-N′,N′-dimethyl-N-p-toyl- | 4.76 |
| sulphamide | |

Paint Examples 2A, 2B, 4 and 6 were each applied to 6 inch by 14 inch (total immersion) and 6 inch by 14 inch (partial immersion) sandblasted steel panels prepared with two coats of anticorrosive epoxy primer and topcoated with two coats of anti-fouling paint. Each coat was applied at 2-3 mil dry film thickness. Comparative samples were prepared by coating panels with heavy metal containing compositions. Comparative Example A is a commercial copper oxide based coating composition and Comparative Example B is a commercially available copper containing ablative coating composition. The painted panels were then immersed into tropic ocean waters for partial immersion evaluation and total immersion evaluation at recognized marine testing sites in Florida. The number of barnacles per panel is reported in Table 1 below. Where a percentage is given, the number of barnacles was not counted, but a percentage of the area covered with barnacles is reported.

TABLE 1

| | Barnacle Count | | | | | |
|---|---|---|---|---|---|---|
| | 8 weeks | | 12 weeks | | 21 weeks | |
| | Partial | Total | Partial | Total | Partial | Total |
| Example 2A | 2.0 | 2.0 | 1.5 | 0 | 8.5 | 8.0 |
| Example 2B | 24.0 | 32.0 | 62.5 | 67.5 | 40% | 38% |
| Example 4 | 1.5 | 1.5 | 2.0 | 1.0 | 6.5 | 3.5 |
| Example 6 | 9.5 | 1.5 | 2.5 | 11.5 | 15.0 | 25% |
| Comp. Ex. A | 2 | 0 | 0 | 0 | 9.0 | 3.0 |
| Comp. Ex. B | 0 | 0 | 0 | 0 | 27.0 | 15% |

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

We claim:

1. A marine self-polishing anti-fouling coating composition comprising:
a polymer binder comprising a film forming polymer having a functional group on the polymer backbone, the functional group chosen from (a) an amine functional group, (b) a cyclic amide functional group, (c) an acid functional group, and (d) a blocked acid functional group; and
a blend of at least two biocidally active materials, the blend comprising a 2-trihalogenomethyl-3-halogeno-4-cyanopyrrole compound and a second biocidally active material,
wherein the coating composition is free of heavy metal containing biocidally active materials.

2. The composition of claim 1 wherein the polymer backbone is chosen from acrylics, polyesters, polyurethanes, alkyds and polyolefins.

3. The composition of claim 1 wherein the polymer backbone comprises an acrylic.

4. The composition of claim 1 wherein the second biocidally active material is an algaecide, fungicide, insecticide, molluscicide or bactericide.

5. The composition of claim 1 wherein the second biocidally active material is an algaecide.

6. The composition of claim 1 wherein the 2-trihalogenomethyl-3-halogeno-4-cyanopyrrole compound comprises 2-(p-chlorophenyl)-3-cyano-4-bromo-5-trifluoromethyl pyrrole.

7. The composition of claim 1 wherein the second biocidally active compound is N-dichlorofluoromethylthio-N′, N′-dimethyl-N-p-toyl-sulphamide.

8. The composition of claim 1 wherein the film forming polymer is formed from at least one acrylic or methacrylic monomer and at least one amine functional monomer.

9. The composition of claim 8 wherein the amine functional monomer is an alkyl amino alkyl (meth)acrylate monomer.

10. The composition of claim 8 wherein the amine functional monomer is chosen from dimethyl amino ethyl methacrylate, diethyl amino ethyl methacrylate, dipropyl amino ethyl methacrylate, dibutyl amino ethyl methacrylate, and combinations thereof.

11. The composition of claim 1 wherein the film forming polymer is formed from at least one acrylic or methacrylic monomer and at least one cyclic amide monomer having the general formula: 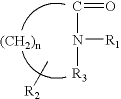
wherein R₁ is selected from H and alkyl groups when R₂ is an alkenyl group, R₁ is an alkenyl group when R₂ is selected from hydrogen and alkyl groups, R₃ is selected from methylene and carbonyl, and n is a positive integer.

12. The composition of claim 11 wherein the cyclic amide is chosen from N-vinylpyrrolidone, N-vinylpiperidone and N-vinyl caprolactam.

13. The composition of claim 1 wherein the film forming polymer is formed from at least one acrylic or methacrylic monomer and at least one acid containing monomer.

14. The composition of claim 13 wherein the acid containing monomer comprises an unsaturated carboxylic acid containing from 3 to about 5 carbon atoms.

15. The composition of claim 13 wherein the acid containing monomer is chosen from acrylic acid, methacrylic acid, itaconic acid, beta carboxy ethyl acrylate, and combinations thereof.

16. The composition of claim 1 wherein the film forming polymer comprises an acid-functional polymer whose acid groups are blocked by groups capable of hydrolyzing, dissociating or exchanging with seawater species to leave a polymer soluble in seawater, the blocking groups comprising quaternary ammonium groups that form a quaternary ammonium salt of the polymers.

17. The composition of claim 16 wherein the blocking groups are derived from dehydroabietyl amine.

18. A marine self-polishing anti-fouling coating composition comprising:
a polymer binder comprising a film forming polymer having a functional group on the polymer backbone, the functional group chosen from (a) an amine functional group, (b) a cyclic amide functional group, (c) an acid functional group, and (d) a blocked acid functional group; and
a blend of at least two biocidally active materials, the blend comprising 2-(p-chlorophenyl)-3-cyano-4-bromo-5-trifluoromethyl pyrrole and N-dichlorofluoromethylthio-N′,N′-dimethyl-N-p-toyl-sulphamide, wherein the coating composition is free of heavy metal containing biocidally active materials.

19. The composition of claim 18 wherein the polymer backbone comprises an acrylic.

20. A method of coating a man made structure immersed in water, comprising coating the structure with the composition of claim 1.
